(19) United States
(12) Patent Application Publication
(10) Pub. No.: US 2016/0153560 A1
(43) Pub. Date: Jun. 2, 2016

(54) Seal for an Electrolyser Cell and Electrolyser Cell Provided with Such a Seal

(71) Applicant: AREVA H2Gen, Paris (FR)

(72) Inventors: Guillaume DOUCET, Marcoussis (FR); Francois LARIDANT, Bourg La Reine (FR); Eric GERNOT, Montlhery (FR)

(21) Appl. No.: 14/904,116

(22) PCT Filed: Jul. 7, 2014
(86) PCT No.: PCT/FR2014/051745

§ 371 Date: Feb. 8, 2016

(30) Foreign Application Priority Data
Jul. 11, 2013 (FR) 1356828

(51) Int. Cl. F16J 15/12; F16J 15/06; F16J 15/10; C25B 9/20; C25B 9/00

(52) U.S. Cl. CPC F16J 15/122; C25B 9/20; C25B 9/00; F16J 15/102; F16J 15/104; F16J 15/061; F16J 15/123

(57) ABSTRACT

A seal for an electrolyser cell and an electrolyser cell provided with such a seal. A seal (100) for an electrolyser cell comprising a core (101) and a shell (201). The core (101) is generally annular and has two faces mutually opposite each other in a thickness direction and at least two openings (111, 113). The two openings (111, 113) are through-openings in the thickness direction and are substantially diametrically opposed to each other. The shell (201) at least partially covers the two faces, leaving the two openings (111, 113) at least partially flee. The shell (201) has at least one first rib (203) extending over a first (103) of the two faces according to a contour enclosing an inner edge (107) of the core (201) and the two openings (111, 113) in such a way as to allow a fluid to circulate between the two faces in the thickness direction.

The invention relates to the industrial production of hydrogen and to electrolyzer devices used individually for this type of production and in particular to solid-electrolyte electrolyzers.

To produce hydrogen industrially, fossil-fuel based processes such as reforming are generally employed. Processes of this type have low operating costs. However they are polluting.

Decentralized industrial production of hydrogen is also carried out by electrolysis of water when production by reforming and/or site delivery are not or not very feasible. In addition, this process is not or not very polluting. Present-day industrial electrolyzer devices comprise a plurality of electrochemical cells, which are supplied with water, and each of which comprises a pair of electrodes.

For reasons of cost and bulk in particular, the cells are generally flat and grouped together into one or more stacks so that two superposed cells have in each instance a common electrode. To decrease costs, especially those related to the manufacture and operation of such stacks, it is generally sought to maximize the number of cells per stack. Present-day solid-electrolyte stacks comprise at most about twenty cells.

The water-electrolysis reaction is driven by applying a DC current between the anode and cathode of each cell, by means of a generator the output voltage of which may be adjustable. Dihydrogen (H₂) and dioxygen (O₂) are thus produced.

The water may be introduced into the cells at low pressure (near atmospheric pressure) or under pressure, depending on the pressure of the dihydrogen (H₂) desired as output. Pressures of about 6 or 7 bars are generally used.

In order for the seals that equip each cell to be able to resist such operating pressures, it is necessary to maintain the cells clamped against one another, in the stacking direction. The clamping force to be applied to a stack depends on the number of cells in the stack and on the pressure of the fluids in the interior of the cells. The seals currently used end up malfunctioning when high clamping forces are used.

The seal tightness of present-day systems is achieved by means of a large number of separate parts that are intended to interact with one another and that are complex to assemble together. The risk of errors during assembly is high and the malfunctions that result therefrom prevent any sort of reliable operation from being achieved.

In other words, at the present time seals that allow both a large number of cells to be stacked and high water pressures to be used do not exist.

As a result, the industrial performance of present-day electrolyzer devices is generally clearly lower than the devices used in production from fossil fuels.

The invention improves this situation.

The Applicant provides a seal for an electrolyzer battery, comprising:
a generally annular core having two faces that are mutually opposite in a thickness direction, and at least two through-apertures extending in the thickness direction and which are substantially radially opposite each other; and
an envelope at least partially covering the two faces while leaving the two apertures at least partially free.

The envelope comprises at least one first rib extending, over a first of the two faces, along a contour enclosing an internal edge of the core and the two apertures so as to allow a fluid to flow between the two faces in the thickness direction.

The seal has a better mechanical strength and increases the leak resistance of large stacks under high pressure.

The Applicant has observed that stacks comprising such seals are resistant to buckling effects that were liable to appear in batteries of large size. Stack length may therefore be further increased with little buckling, thereby further decreasing the risk of battery leakage and degradation.

Creep effects are also particularly decreased by the use of such seals. It is thus possible to also increase clamping forces and operating pressures and therefore the efficiency of the electrolyzer batteries.

Electrolyser batteries comprising such seals thus form hydrogen producing devices that are ecologically acceptable. These devices are furthermore industrially reliable and profitable. Such seals are inexpensive to manufacture and easy to assemble.

These seals remain effective under critical operating conditions such as high temperatures and/or humidity levels, but also during interactions with battery parts having high dimensional tolerances.

The seal may furthermore have the following features, which may optionally be combined together:
The envelope has a configuration and a composition that are adapted so as to electrically insulate two members making contact with one and the other of the two faces, respectively. In the electrolyzer battery, the seal in the installed state therefore provides an electrical insulation function in addition to its sealing function.
The core has a metallic composition and the envelope has an elastomer-based composition. The elastomer has a higher deformability than that of the metal. The core stiffens the seal and improves its mechanical strength whereas the elastomer deforms on contact and improves the seal tightness.
The envelope has a composition comprising ethylene-propylene-diene monomer (EPDM). EPDM furthermore preserves its mechanical and sealing properties under severe operating conditions while having a limited cost. The lifetime of the seal under stress is thus improved.
The envelope adheres to the core. The seal thus exhibits a good resistance under stress. The risk of complete or partial detachment of the envelope from the core is low.
The envelope furthermore has at least one second rib protruding from the first face and extending between the first rib and an external edge of the core. The combination of two ribs provides the seal with two separate zones of contact in the assembled state. The position of the seal in a stack is then stable and durable. The second rib thus forms an additional sealing barrier.
The aforementioned second rib extends along an open contour partially encircling the first rib. Thus, the equilibration of the pressures between the inter-rib space and the exterior of the seal is facilitated. Air-cushion or sucker effects are avoided. Furthermore, the second rib forms a guide for collecting any fluid that escapes from the interior of the battery.
The core furthermore comprises two additional through-apertures that extend in the thickness direction and that are substantially radially opposite each other. The envelope leaves the two additional apertures at least partially free. The envelope furthermore comprises two additional ribs extending, over the first face, along a contour enclosing each of the two additional apertures, respectively. When the seal is in the assembled state in a stack with other corresponding seals, said additional apertures then form segments of two passages extending substantially in the stacking direction. The two passages are sealed from the rest of the seal. Passages for the supply of fluid to the stack are thus accommodated in the seals.
One of the two apertures and one of the aforementioned two additional apertures are close to each other. When the seal is in an assembled state in a stack, the fluid passages extending in the stacking direction are thus grouped together circumferentially. The supply of the stack is facilitated and the bulk of the battery may be decreased. The removal of gas or of gas-containing water may be facilitated by orienting the battery so that the passages that form outlets are located in top positions relative to the rest of the battery.
At least one rib has an asymmetric cross section so that crushing said rib in the thickness direction generates an asymmetric deformation of said rib. In the compressed state, dilation of the rib does not impede the electrolysis from operating correctly.
The aforementioned asymmetric cross section has a generally trapezium shape. In this case one of the sides deforms into a sealing and immobilizing bulge whereas the opposite side bears against the part adjacent to the seal during the compression, thereby improving the seal tightness.
The envelope has a rib extending over the face opposite that bearing the first rib and along a contour enclosing the internal edge. Said rib is shaped so as to deform essentially in the thickness direction in response to crushing in the thickness direction.
An external edge of the core has at least one abutment zone able to interact with a guide of an electrolyzer battery in order to immobilize the seal in said electrolyzer battery in a direction perpendicular to the stacking direction. The immobilization and maintenance of the seal in the stack is facilitated. Buckling effects and mounting approximations are limited.

According to another aspect, the Applicant provides an electrochemical cell comprising two seals such as defined above, which seals are mutually placed so that the second of the two faces of the two seals are mutually facing.

According to a third aspect, the Applicant provides an electrolyzer battery comprising a stack of electrochemical cells such as defined above. The stack of such a battery may optionally comprise 100, 150, 200 or even 300 electrochemical cells at least.

The similarity between two seals of a given cell allows manufacturing costs to be decreased and facilitates maintenance of the battery. The risks of mounting errors are decreased. Such a battery has a good efficiency and a low bulk.

Other features, details and advantages of the invention will become apparent on reading the detailed description below, and the appended drawings, in which:

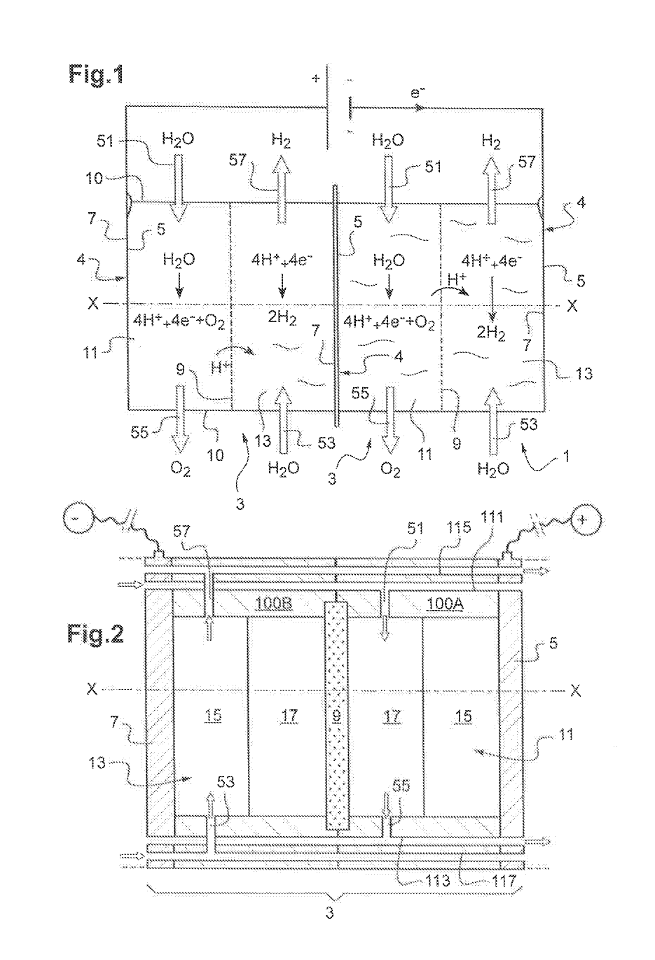

FIG. 1 is a schematic representation of water-electrolysis cells in a battery;

FIG. 2 is a schematic representation of the operation of an electrolysis cell according to the invention;

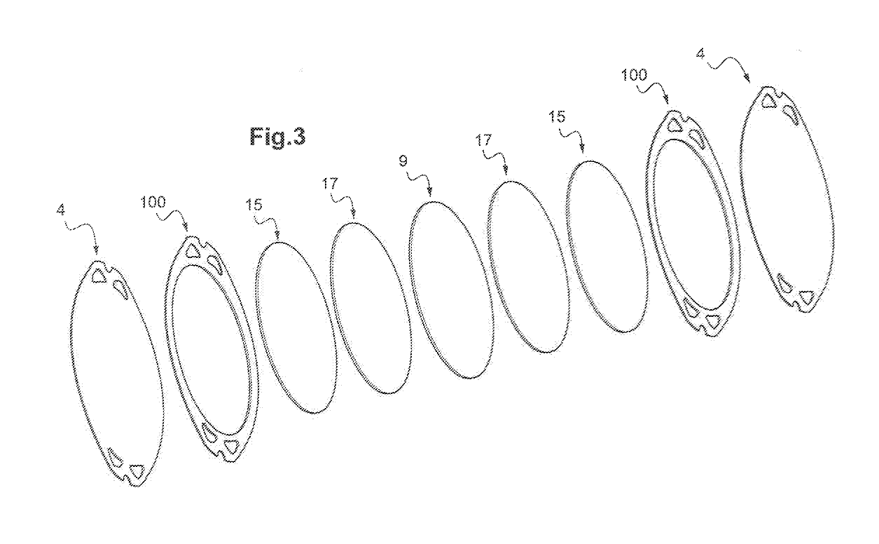

FIG. 3 is an exploded perspective view of an electrolysis cell according to the invention;

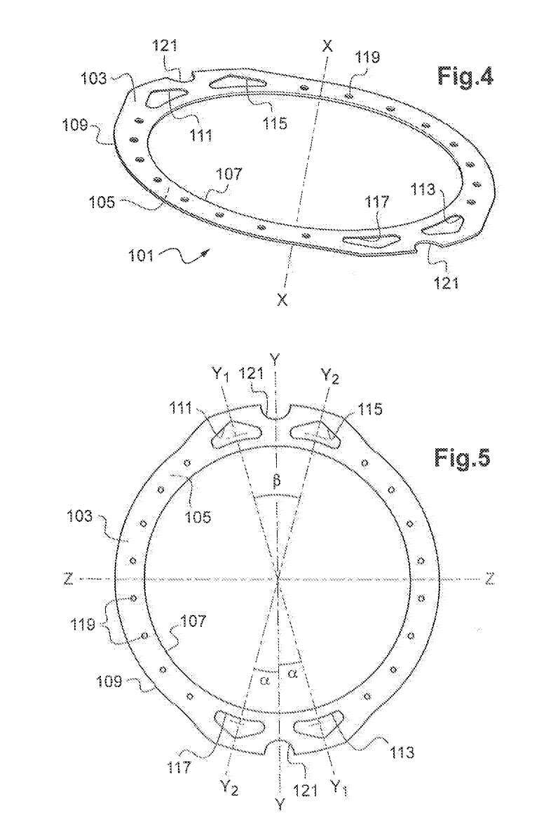

FIG. 4 is a perspective view of a portion of a seal according to the invention;

FIG. 5 is a top view of the portion shown in FIG. 4;

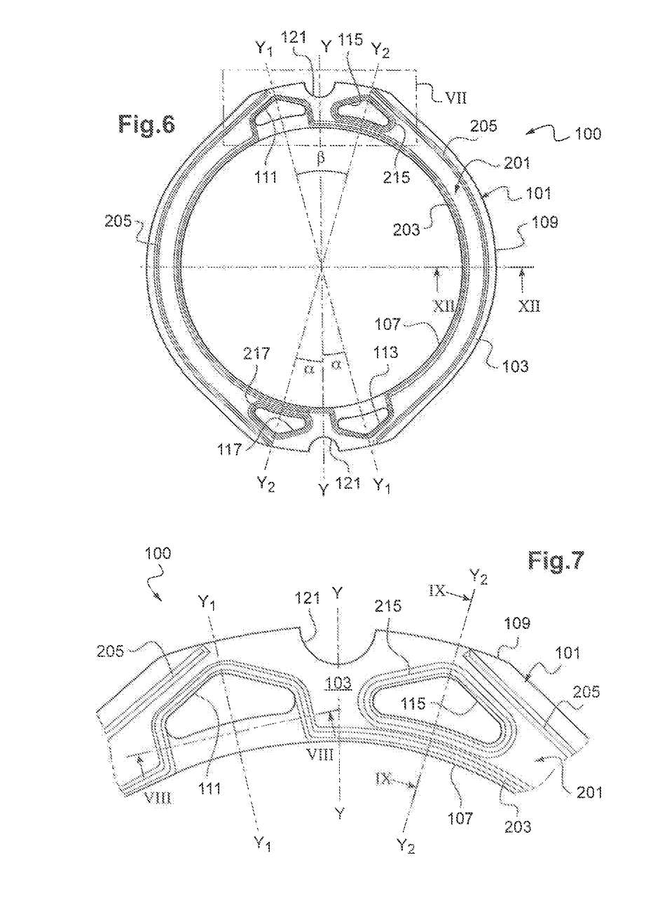

FIG. 6 is a top view of a seal according to the invention;

FIG. 7 is a view of the detail VII in FIG. 6;

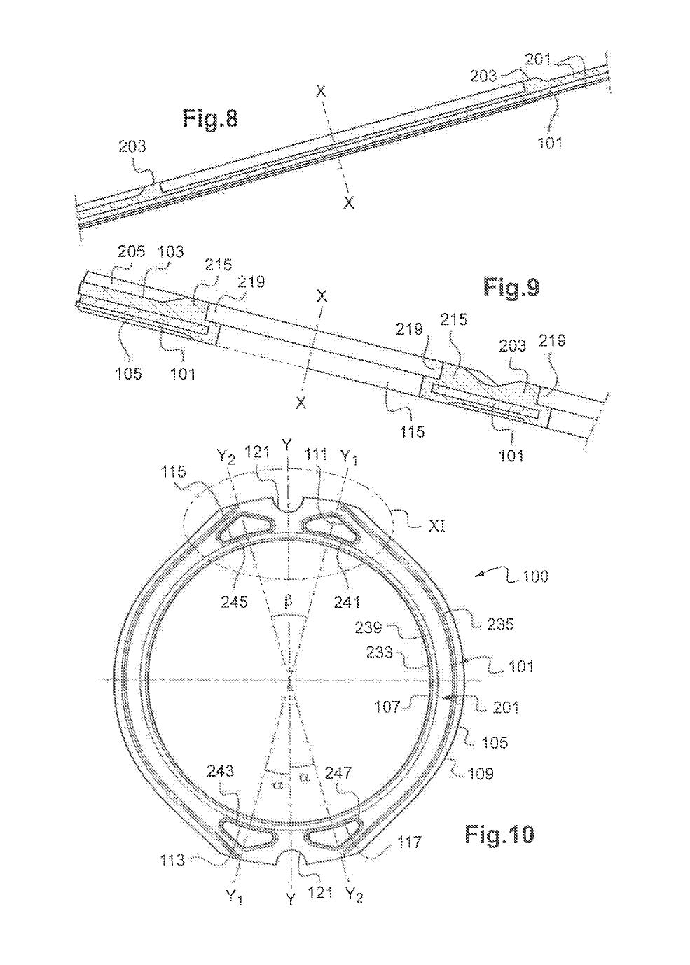

FIG. 8 is a cross-sectional view of the plane VIII in FIG. 7;

FIG. 9 is a cross-sectional view of the plane IX in FIG. 7;

FIG. 10 is a bottom view of the seal in FIG. 6;

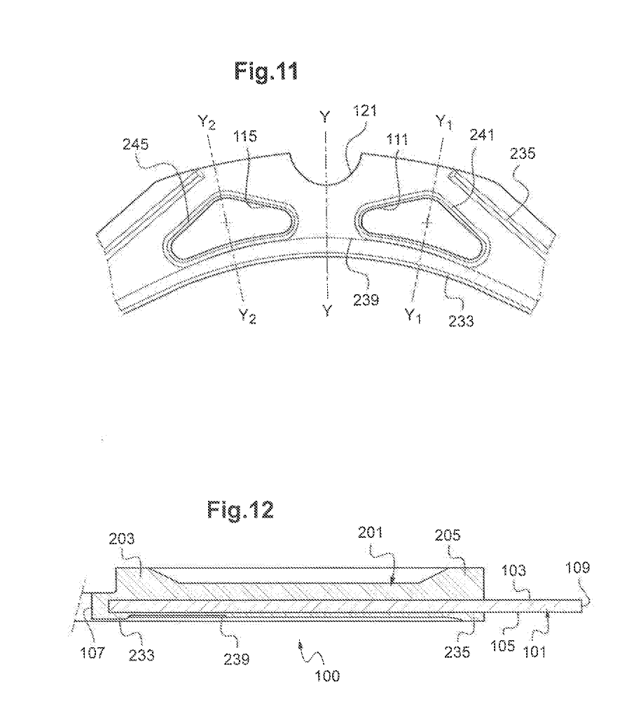

FIG. 11 is a view of the detail XI in FIG. 10;

FIG. 12 is a cross-sectional view of the plane XII in FIG. 6; and

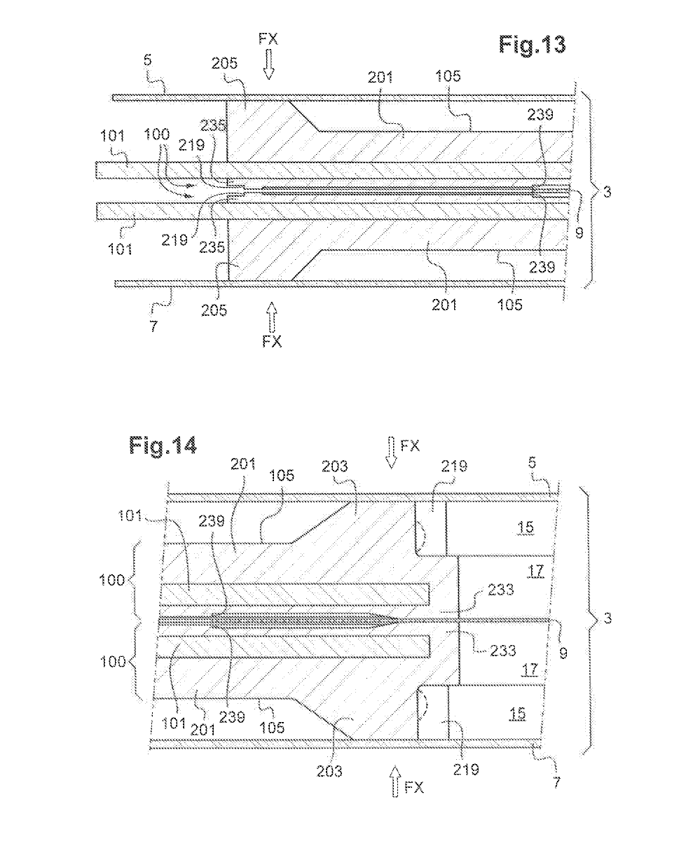

FIGS. 13 and 14 are detail views of a cross section of a cell according to the invention.

The drawings and the description below contain, for the most part, elements of certain nature. They therefore may not only be used to gain a better understanding of the present invention but also, where appropriate, contribute to its definition.

Reference is made to FIG. 1.

An electrolyzer battery 1 comprises a plurality of water-electrolysis cells 3 stacked on top of one another in a first direction, or stacking direction XX. Only two cells 3 are shown in FIG. 1.

Each cell 3 comprises two electrodes, a proton exchange membrane (PEM) 9 and one or more external walls 10.

The two electrodes are each borne by a bipolar plate 4. A bipolar plate 4 comprises two faces that are opposite each other. A first face forms an anode 5 of a first cell 3, whereas a second face forms a cathode 7 of a second cell adjacent to the first cell. A bipolar plate 4 is placed at the interface of two adjacent cells. In other words, each electrode of a given cell belongs to a respective bipolar plate 4 common to two adjacent cells of the stack.

The two bipolar plates 4 bearing the electrodes of a given cell are of substantially planar shape. The electrodes are installed substantially parallel to each other and perpendicular to the stacking direction XX of the cell 3. The two electrodes are here of identical structure and composition.

The PEM membrane 9 is placed between the two electrodes and substantially parallel to the electrodes.

The space between the anode 5 and the PEM membrane 9 defines a first compartment 11. The space between the cathode 7 and the PEM membrane 9 defines a second compartment 13. The first compartment 11 and the second compartment 13 each mainly contain water. Preferably, deionized water is used. For example, the water has a conductivity lower than 1 μS·cm⁻².

The external walls 10 extend substantially in the stacking direction XX and bound the first compartment 11 and the second compartment 13 perpendicularly to the stacking direction XX. A first water inlet 51 is produced through the external wall 10 in such a way as to open into the first compartment 11. A second water inlet 53 is produced through the external wall 10 in such a way as to open into the second compartment 13. An outlet 55 of the first compartment 11 is produced through the external wall 10. The outlet 55 of the first compartment 11 takes the form of a passage suitable for removing water containing dioxygen (O₂) in gaseous form. An outlet 57 of the second compartment 13 is produced through the external wall 10. The outlet 57 of the second compartment 13 takes the form of a passage suitable for removing water containing dihydrogen (H₂) in gaseous form.

Applying an electrical voltage between the anode 5 and the cathode 7 drives the electrolysis reactions. In the first compartment 11, the following reaction (1) takes place:

2H₂O→4H⁺+4e⁻+O₂ (1)

Protons (H⁺) originating from the reaction (1) in the first compartment 11 migrate through the PEM membrane 9 into the second compartment 13. In the second compartment 13, the following reaction (2) takes place:

4H⁺+4e⁻→2H₂ (2)

The reactions (1) and (2) within the electrolysis battery 1 are controlled by adjusting the DC current or voltage applied to the electrodes.

The anode 5, at one of the ends, and the cathode 7, at the other end of the electrolysis battery 1, are intended to be connected to a DC current generator. The electrical connections and the current source common to the cells 3 of the battery 1 are not shown.

The first water inlet 51, the second water inlet 53, the dioxygen (O₂) outlet 55 and the dihydrogen (H₂) outlet 57 of each cell 3 of the battery 1 may be fluidically connected to the homologous inlets/outlets of other cells 3 of the battery 1. Thus, the first water inlets 51 of a battery 1 are supplied by a common water source, the second water inlets 53 of a battery 1 are supplied by a common water source, the dioxygen (O₂) outlets of a battery 1 are connected to a common collector and the dihydrogen (H₂) outlets of a battery 1 are connected to a common collector.

The second water inlets 53 improve thermal regulation and limit the drying of the PEM membrane 9. As a variant, the second water inlets 53 on the cathode 7 side are omitted.

FIG. 2 shows one embodiment of a cell 3 such as shown in FIG. 1. The cell 3 comprises a first seal 100A, a second seal 100B, two diffusers 15 and two porous current collectors 17.

The PEM membrane 9 is inserted and pinched, or sandwiched, between the first seal 100A and the second seal 100B. The first seal 100A/PEM membrane 9/second seal 100B assembly is itself inserted between the anode 5 and the cathode 7. The first seal 100A and the second seal 100B are here of generally annular shape and separate an internal space and an external space of the cell 3. The first seal 100A and the second seal 100B here form the external walls 10 of the cell 3. The interior of the first seal 100A corresponds to the first compartment 11 whereas the interior of the second seal 100B corresponds to the second compartment 13. Each of the first compartment 11 and the second compartment 13 houses a diffuser 15, on the anode 5 and cathode 7 side, respectively, and a porous current collector 17 on the PEM membrane 9 side. The seals 100A and 100B furthermore form the electrical insulators between the anode 5, the cathode 7 and the PEM membrane 9.

In the example described here, the first and second compartments 11 and 13, the two seals 100A, 100B, respectively, the two diffusers 15, respectively, and the two porous current collectors 17, respectively, are identical. As variants, the homologous portions on either side of the PEM membrane 9 have similar dimensions and shapes and minor differences.

In the assembled state of the cell 3, the face forming the anode 5 of the first bipolar plate 4 bears against the first seal 100A, the first seal 100A bears against the PEM membrane 9, the PEM membrane 9 bears against the second seal 100B and the second seal 100B bears against the face forming the cathode 7 of the second bipolar plate 4. In the clamp state of the cell 3, the anode 5, the first seal 100A, the PEM membrane 9, the second seal 100B and the cathode 7 are clamped together in the stacking direction XX. The stacking direction XX also corresponds to a clamping direction and to a thickness direction of the bipolar plates 4, of the first seal 100A, of the PEM membrane 9 and of the second seal 100B.

The dimensions of the diffusers 15 and porous current collectors 17 are adjusted so as to substantially fill their compartment 11 or 13. The clamping of the first seal 100A between the anode 5 and the PEM membrane 9 on the one hand, and of the second seal 100B between the cathode 7 and the PEM membrane 9 on the other hand, ensures the seal tightness and makes the electrical contacts. The first compartment 11 and the second compartment 13 are fluidically isolated from the exterior of the cell 3.

Reference is now made to FIG. 3. In the embodiment described here, the PEM membrane 9 has a disc shape. Its diameter is here about 298 millimeters. Its thickness is comprised between about 0.2 and 0.4 millimeters.

The bipolar plates 4 take the form of generally circular planar plates. The bipolar plates 4 each have an exterior edge corresponding to the shape of the seals 100A and 100B. As a variant, the external edge of the anode 5 and/or the external edge of the cathode 7 have a connector for a connection to the current source. The anode 5 and the cathode 7 are produced from an electrically conductive material, for example from titanium.

In the example described here, the diffusers 15 take the form of disc-shaped grids. As a variant, the diffusers 15 may take other forms suitable for homogenizing the flow of fluids in the compartments 11 and 13. The diameter is, here, about 275 millimeters. The thickness is 1 millimeter and may vary between about 0.9 and 1.2 millimeters. The diffusers 15 are produced from an electrically conductive material, for example one based on titanium. The diffusers 15 here take the form of a mesh. The mesh is arranged so that a flow of fluid in the direction of the principal plane of the diffuser 15 is made as uniform as possible by spreading in the directions of the plane. For example, the mesh cells form a rhombus of 4.5 by 2.7 millimeters.

As a variant, the diffusers 15 may be produced by means of a bank of channels formed in the anode 5 on the one hand and in the cathode 7 on the other hand.

In yet another variant, the diffuser 15 is omitted on the cathode 7 side. This variant is preferred when the second water inlets 53 are omitted and no provision is made for water to flow through the compartment 13.

The porous current collectors 17 have a disc shape. Their diameter is here about 275 millimeters. The thickness is 1.5 millimeters and may vary between 1.3 and 1.8 millimeters. The porous current collectors 17 are produced from an electrically conductive material that is also permeable to liquids, for example from sintered titanium.

The shapes and outside dimensions of the diffusers 15 and porous current collectors 17 correspond to the shapes and inside dimensions of the seals 100A and 100B in the interior of which the diffusers 15 and porous current collectors 17 are housed. A mounting loose-fitting gap is provided in order to allow for expansion of the diffusers 15, of the porous current collectors 17 and of the seals 100A, 100B in operation. The PEM membrane 9 has a diameter larger than the inside diameter of the seals 100A and 100B so as to be insertable between the first seal 100A and the second seal 100B. The bipolar plates 4 for their part have shapes and dimensions that allow them to be brought to bear against the first seal 100A and the second seal 100B, respectively.

Each bipolar plate 4 belongs to two adjacent cells 3 of the stack with the exception of the two end electrodes of the stack. For example, the bipolar plate 4 at the center of FIG. 1 is common to the two cells 3.

The anode 5, the cathode 7, the two diffusers 15 and the two porous current collectors 17 of the cell 3 have a generally disc shape. The first seal 100A and the second seal 100B are of generally annular shape. The substantially axisymmetric shapes facilitate pressure withstand and a uniform distribution of the water in the cells 3. The uniformity of the reactions within the cell 3 is good. The annular and circular shapes remain optional. As variants, the cell 3 may, when viewed in the stacking direction XX, have a generally rectangular or square shape or any other suitable closed shape. Furthermore, the dimensions given above by way of example may be different depending on the desired application.

As a variant, the PEM membrane 9 is replaced by an anionic membrane. In this case, the electrolyte is basic instead of acid. Hydroxide anions (HO) pass through the anionic membrane. The chemical reactions in the compartments are modified but the structure and operation of the battery 1 remains similar.

FIGS. 4 to 12 show one embodiment of a seal 100, which may be used as the first seal 100A and/or the second seal 100B. The seal 100 comprises a core 101 and an envelope 201 at least partially covering the core 101.

Reference is first made to FIGS. 4 and 5 in which the core 101 is shown bare, i.e. devoid of envelope 201. The core 101 is of generally annular shape.

The core 101 has two main faces 103, 105 that are opposite each other and perpendicular to a thickness direction of the seal 100. When the seal 100 is in the assembled state in a stack, the thickness direction of the seal 100 is parallel to the stacking direction XX.

The core 101 is of substantially flat shape. The core 101 has an internal edge 107 and an external edge 109. The core 101 has a ring shape: the width in its main plane perpendicular to the thickness direction is substantially larger than its thickness.

The core 101 comprises a first aperture 111, a second aperture 113, a third aperture 115 and a fourth aperture 117. The four apertures 111, 113, 115, 117 are through-apertures extending in the thickness direction. The first aperture 111 and the second aperture 113 are substantially radially opposite each other. The third aperture 115 and the fourth aperture 117 are substantially radially opposite each other. The four apertures 111, 113, 115, 117 each have a closed outline. In operation, the four apertures 111, 113, 115, 117 allow a fluid to flow between the first main face 103 and the second main face 105 through the core 101. Here, the shapes of the four apertures 111, 113, 115, 117 are similar and each has a plane of symmetry parallel to the thickness direction, and extending along a diameter of the annular shape of the core 101. The planes of symmetry of the first aperture 111 and the second aperture 113 are common and referenced Y₁. The planes of symmetry of the third aperture 115 and the fourth aperture 117 are common and referenced Y₂.

In the embodiment described here, the four apertures 111, 113, 115, 117 are distributed unequally around the circumference of the core 101. To define their circumferential positions, the center of each of the apertures 111, 113, 115, 117 in the main plane of the core 101, belonging to one of their planes of symmetry Y₁ and Y₂, is used as a reference. The first aperture 111 and the third aperture 115 are mutually spaced around the circumference of the core 101 by an angle β equal to 2α. Likewise, the second aperture 113 and the fourth aperture 117 are mutually spaced around the circumference of the core 101 by the angle β equal to 2α. The core 101 thus has a first plane of symmetry Y parallel to the thickness direction making an angle α to the plane Y₁ on the one hand and to the plane Y₂ on the other hand. α is preferably smaller than 22.5° and here is substantially equal to 15°. The core 101 has a second plane of symmetry Z, parallel to the thickness direction and perpendicular to the plane of symmetry Y. The first aperture 111 and the third aperture 115 are close together while the second aperture 113 and the fourth aperture 117 are close together. This particular arrangement has the advantage of circumferentially grouping the passages for the fluids together in an assembled state of the seal 100. By placing the electrolysis battery 1 so that the stacking direction XX is substantially horizontal, the inlets 51 and 53 may be placed at the bottom whereas the outlets 55 and 57 may be placed at the top. The removal of the gases via the outlets 55 and 57 is facilitated by the effect of Archimedes' principle. This arrangement remains optional.

The two circumferential segments of the core 101, in which the first aperture 111 and the third aperture 115, on the one hand, and the second aperture 113 and fourth aperture 117, on the other hand, are housed are called “aperture segments”. The two circumferential segments connecting the two aperture segments are called “current segments”.

The internal edge 107 is circular. The internal edge 107 for example has a diameter of about 278 millimeters. The external edge 109 segments of the current segments form two concentric circular arcs. The external edge 109 segments of the current segments lie on a circle of about 340 millimeters diameter. The width of the current segments is substantially invariable around the circumference.

The external edge 109 segments of the aperture segments form two concentric circular arcs. The external edge 109 segments of the aperture segments lie on a circle of about 365 millimeters diameter. The external edge 109 segments of the current segments and of the aperture segments are joined, substantially continuously. The variation in the outside diameter of the external edge 109 forms an exception to the generally annular character of the core 101.

The external edge 109 segments of the aperture segments each comprise an abutment zone 121. Each abutment zone 121 here takes the form of a notch of semicircular shape. The abutment zones 121 are placed radially opposite each other. The two abutment zones 121 are placed between the first aperture 111 and the third aperture 115, on the one hand, and between the second aperture 113 and the fourth aperture 117, on the other hand. The abutment zones 121 are able to cooperate with a guide of a battery 1. The abutment zones 121 facilitate the indexation of the seals 100 during the mounting of the battery 1 and improve the hold achieved thereof by a structure external to the seal 100. As a variant, the abutment zones 121 may have any other shape and/or arrangement in the core 101 in correspondence with immobilizing members of a battery. This feature remains optional.

In the example shown here, the core 101 furthermore comprises through-holes 119 distributed substantially regularly around the circumference of the current segments of the core 101. The holes 119 improve the attachment of the envelope 121 around the core 101 and facilitate the manufacture of the seal 100.

The thickness of the core 101 is substantially invariable and comprised between 0.5 and 2 millimeters, for example about 0.8 millimeters. The core 101 is produced based on metal, for example stainless steel. As a variant, the shapes, dimensions and compositions of the core 101 will possibly be different and have equivalent mechanical strength properties.

Reference is now made to FIGS. 6 and 7 showing the seal 100 ready to be assembled into a battery 1. The seal 100 comprises the core 101 partially covered by the envelope 201. The envelope 201 adheres to the core 101. In the example described here, the seal 100 is obtained by injection molding of the constituent material of the envelope 201 in contact with the core 101. The envelope 201 here has a composition based on ethylene-propylene-diene monomer (EPDM). The composition of the envelope 201 has an elasticity higher than that of the composition of the core 101. The EPDM used here allows improved mechanical properties, and in particular resistance to extreme temperatures, to be obtained relative to other elastomers. The use of EPDM rather than other elastomers remains optional. For example, fluoropolymers (FKM), ethylene vinyl acetates (EVA and EVM) and chlorinated polyethylenes (CM) may be used depending on the desired application.

The envelope 201 covers, here only partially, the first main face 103 and the second main face 105 of the core 101. The through-apertures 111, 113, 115, 117 are left free. The flow of a fluid from one face to the other in the thickness direction is thus possible. The holes 119 are filled by the envelope 201.

In FIG. 6, the only portions of the core 101 that may be seen are the radially exterior segments of the current segments, on the right- and left-hand side of the figure. As may be better seen in FIG. 12, the envelope 201 also covers the internal edge 107. The external edge 109 is left free.

The envelope 201 has a first internal rib 203. The internal rib 203 extends continuously over the first face 103. The internal rib 203 extends along a contour enclosing the internal edge 107, the first aperture 111 and the second aperture 113. In other words, the internal edge 107, the first aperture 111 and the second aperture 113 are ringed by the internal rib 203.

In the example shown here, the closed contour of the internal rib 203 corresponds to the shape of the internal edge 107 and to the shapes of the first and second apertures 111 and 113. The internal rib 203 follows the internal edge 107 and a portion of the outlines of the first and second apertures 111 and 113. Positioning the internal rib 203 in proximity to the internal edge 107 and the first and second apertures 111 and 113 limits cavitation and non-laminar flow effects in the cells 3 in the assembled state and while the seals 100 are in operation. As a variant, the internal rib 203 traces a path away from the internal edge 107 and/or the first and second apertures 111 and 113, in particular when the laminar nature of the flows is not considered to be a critical parameter.

As may be more easily seen in FIG. 8, a first passage is preserved substantially in a radial direction between the interior space of the seal 100 and the first aperture 111. A second passage is preserved substantially in a radial direction between the interior space of the seal 100 and the second aperture 113. The two passages are bounded circumferentially by segments of the internal rib 203. Fluid may flow in a substantially radial direction between the first aperture 111 and the free space at the center of the seal 100, and between the second aperture 113 and the free space at the center of the seal 100. In an assembled state of the seal 100, each of these passages defines one of the inlets/outlets 51, 53, 55, 57 of one among the first compartment 11 and the second compartment 13.

In the example shown here, the envelope 201 covers those portions of the first face 103 of the core 101 which are located between the first aperture 111 and the neighboring internal edge 107 segment, on the one hand, and between the second aperture 113 and the neighboring internal edge 107 segment, on the other hand. This allows the core 101 to be electrically insulated from the other parts of the cell 3 and especially from the diffusers 15 and the porous current collectors 17. Chemical degradation of the core 101 by the fluids of the cell 3 is furthermore limited. As may be seen in FIG. 8, the portion of the envelope 201 covering the core 101, between the interior space of the seal 100 and the first aperture 111 and second aperture 113, respectively, has a smaller thickness than that of the rest of the envelope 201 covering the first face 103. The first and second passages thus have a substantial flow cross section. This feature is optional: the thickness of the envelope 201 may be uniform throughout the seal 100 (with the exception of the ribs).

The envelope 201 comprises a second external rib 205. The external rib 205 extends over the first main face 103. The external rib 205 extends substantially along the external outline 109. The external rib 205 protrudes from the first main face 103 between the internal rib 203 and the external edge 109. In the example described here, the external rib 205 comprises two separate segments. The external rib 205 is interrupted level with the aperture segments. In other words, the segments of the seal 100 between the first aperture 111 and the third aperture 115, on the one hand, and between the second aperture 113 and the fourth aperture 117, on the other hand, are devoid of the external rib 205. The two segments of the external rib 205 may thus be considered to be two ribs as such.

The external rib 205 improves the mechanical stability of the seal 100 in the installed and compressed state within a battery 1 by forming a bearing zone. Furthermore, the second rib 205 forms a second sealing barrier in the current segments complementing the first sealing barrier formed by the internal rib 203 in the installed and compressed state of the seal 100. The external rib 205 facilitates the assembly of the battery 1 and improves the withstand of the seal 100 in the compressed state. The external rib 205 remains optional.

The discontinuity in the external rib 205 facilitates the equilibration of the pressures between the space on the internal side and the space on the external side of the external rib 205 in a compressed state of the seal 100. A “sucker effect” is avoided. Furthermore, in the case of accidental escape of gas and/or liquid to the external side of the internal rib 203, the fluids are guided by the external rib 205 toward previously identified zones, here the aperture segments. Thus, detection and/or recovery of escaped fluids are facilitated. The discontinuity in the external rib 205 remains optional. As a variant, drill holes may be produced between the internal rib 203 and the external rib 205 and in the thickness direction XX in order to facilitate recovery of escaped fluids in the case of a defect in the seal tightness provided by the internal rib 203.

In the embodiment described here, the envelope 201 comprises two additional ribs that are what are called aperture ribs 215 and 217. The aperture ribs 215 and 217 extend over the first main face 103. Each of the two aperture ribs 215 and 217 extend continuously along a closed contour encircling the third aperture 115 and the fourth aperture 117, respectively. The interior space of the third aperture 115 and of the fourth aperture 117, respectively, is hermetically isolated from the space located between the internal rib 203 and the external rib 205 when the seal 100 is in an installed and compressed state in a battery 1. In other words, fluid may flow substantially in the stacking direction XX in the third aperture 115 and in the fourth aperture 117, respectively, while remaining confined therein in the plane of FIG. 6. Furthermore, the seal 100 is devoid of passages in the radial direction between the interior of the third aperture 115 and the interior space of the internal edge 107 and between the interior of the fourth aperture 117 and the interior space of the internal edge 107, respectively.

Reference is now made to FIGS. 8, 9 and 12. The internal rib 203 has a cross section that is substantially invariable all the way around the circumference of the seal 100, including around the first aperture 111 and second aperture 113. The internal rib 203 here has an asymmetric cross section. Said cross section ensures that the internal rib 203 deforms as required under the effect of crushing in the thickness direction. In the example described here, the cross section has a side oriented toward the interior of the seal 100 that is substantially right and perpendicular to the first main face 103. The cross section has an opposite side, i.e. a side oriented toward the exterior of the seal 100, that is inclined. The inclined side is oriented substantially at 45° to the first main face 103. The perpendicular side and the inclined side are joined by an end surface, i.e. a surface oriented away from the core 101, which is substantially planar and parallel to the first main face 103. The asymmetric cross section thus has a generally trapezoid shape. Since the cross section is asymmetric, the trapezoid is not an Isosceles trapezoid. Since the internal side is perpendicular to the first main face 103 and to the end surface, the trapezoid is furthermore a rectangle trapezoid. As a variant, the internal rib 203 may have an asymmetric shape other than a trapezoid shape. The asymmetry of the cross section of the internal rib 203 remains an optional feature.

The internal rib 203 protrudes in the thickness direction by a value comprised between 0.5 and 1.5 millimeters in the non-compressed state, for example about 1 millimeter.

The external rib 205 and the aperture ribs 215 and 217 have cross sections that are substantially invariable and similar to those of the internal rib 203. The perpendicular side of the trapezoidal shape of the external rib 205 is oriented to the seal 100 external edge 109 side, whereas the inclined side is oriented to the internal edge 107 side. The perpendicular side of the aperture ribs 215 and 217, respectively, is oriented to the third aperture 115 and fourth aperture 117 side, respectively. The inclined side of the aperture ribs 215 and 217, respectively, is oriented toward the exterior of the third aperture 115 and fourth aperture 117, respectively. The shapes of the cross sections of the various ribs 203, 205, 215, 217 ensure said ribs expand as required.

In particular, under the effect of a compression in the thickness direction:
the perpendicular side of the internal rib 203 tends to deform into a rounded bulge protruding toward the center of the seal 100 whereas a portion of the inclined side makes contact with the neighboring anode 5 or cathode 7, thereby gradually increasing the sealing contact zones as the compression increases;
the perpendicular side of the external rib 205 tends to deform into a rounded bulge protruding toward the exterior of the seal 100 whereas a portion of the inclined side makes contact with the neighboring anode 5 or cathode 7, thereby gradually increasing the sealing contact zones as the compression increases; and
each of the perpendicular sides of the aperture ribs 215, 217 tends to deform into a rounded bulge protruding toward the interior of the aperture 215 and 217, respectively, whereas a portion of the inclined side makes contact with the neighboring anode 5 or cathode 7, thereby gradually increasing the sealing contact zones as the compression increases.

As may be seen in FIGS. 9 and 14 especially, the perpendicular sides of the ribs 203, 215, 217 are arranged so as to form recesses 219 in the material of the envelope 201. In other words, the perpendicular side of said ribs 203, 215, 217 is set back relative to the interior edges of the apertures 111, 113, 115, 117 so as to allow the bulge expansion without decreasing the flow cross sections of said apertures 111, 113, 115, 117. Likewise, the perpendicular side of the internal rib 203 is arranged so as to form a recess 219 relative to the internal edge 107. The recesses 219 provide the seals 100 with a tolerance with respect to the dimension variation and expansion of the diffusers 15 and seals 100 in operation. The seals 100 and the diffusers 15 are mutually adjusted so that the bulge makes contact with the diffuser 15 without deforming it during the compression. The diffuser 15 is then immobilized by the bulge.

Thus, the bulge expansion of said ribs 203, 215, 217 in the plane perpendicular to the thickness direction does not inhibit the passage of fluid through the apertures 111, 113, 115, 117 and preserves the integrity of the first compartment 11 and of the second compartment 13. Although advantageous, the recesses 119 remain optional.

Reference is now made to FIGS. 10 and 11, seen from the second main face 105 side. In the example shown here, the envelope 201 partially covers the second main face 105 of the core 101. The portion of the envelope 201 partially covering the second face 105 is similar to that on the first main face 103 side while having the following differences:
The internal rib, here referenced 233, extends along the internal edge 107 around the entire circumference of the seal 100 without being placed around the first aperture 111 and the second aperture 113. On the second face 105 side, the seal 100 is devoid of a radial passage between the interior space of the seal 100 and the first aperture 111 and second aperture 113, respectively.
The external rib is here referenced 235.
An aperture rib 241 encloses the first aperture 111 and an aperture rib 243 encloses the second aperture 113.
The aperture rib enclosing the third aperture 115 and the fourth aperture 117, respectively, is here referenced 245 and 247, respectively.
The shapes and dimensions of the cross sections of the ribs 231, 233, 241, 243, 245, 247 on the second main face 105 side are different from those on the first main face 103 side. In particular, the dimensions of said ribs 231, 233, 241, 243, 245, 247 on the second main face 105 side, in the thickness direction, are substantially smaller than their homologues on the first main face 103 side. Here, the ribs 231, 233, 241, 243, 245, 247 protrude in the stacking direction by about 0.2 millimeters. The ribs 231, 233, 241, 243, 245, 247 are shaped so as to deform essentially in the thickness direction XX in response to crushing in the thickness direction XX. In particular, the deformation of the internal rib 233 in the main plane of the seal 100 is zero or negligible. Thus, when in the assembled state in a battery 1 and making contact with the PEM membrane 9, the deformation of the internal rib 233 exerts no or little tensile stress on the PEM membrane 9. The integrity of the PEM membrane 9 is preserved.

Reference is now made to FIGS. 13 and 14, which show two seals 100 that are in the assembled state in a stack but not compressed. FIG. 14 shows a portion of the internal side of the assembly in the same cross-sectional plane as that in FIG. 13. The assembly shown forms one cell 3. A first seal 100 (top seal in FIGS. 13 and 14) is placed facing a second seal 100 (bottom seal in FIGS. 13 and 14) so that their respective second main faces 105 face each other. A PEM membrane 9 is wedged in the stacking direction XX between the two seals 100. An anode 5 is placed against the first seal 100 (above in FIGS. 13 and 14) and a cathode 7 is placed against the second seal 100 (below in FIGS. 13 and 14). The cross section shown is through a current segment of the assembly, away from the through-apertures 111, 113, 115, 117. In these current sections, the mounting has a symmetry about a plane corresponding substantially to the plane of the PEM membrane 9.

In the figures, the seals 100 are shown in an unconstrained state. The arrows referenced FX show the directions of application of the compressive forces applied to the cell 3 in the stacking direction XX in a compressed state.

A shoulder 239 is provided along the circumference in the second main face 107 of the envelope 201 of each of the seals 100. The shoulder is oriented toward the interior of the seals 100. The shoulder 239 lies substantially on a circle, which here has a diameter of about 293 millimeters. The shoulder 239 is radially positioned between the internal rib 233, on the one hand, and the through-apertures 111, 113, 115 and 117, on the other hand. The shoulder 239 forms an abutment, or at least a point of reference, facilitating the positioning of the PEM membrane 9 between the two seals 100 during the mounting. The shoulder 239 remains optional.

The perpendicular sides of the ribs 203, 205 in the deformed and compressed, radially protruding bulge-shaped form are shown by dashed lines.

Assembly of the seals 100 in the battery 1 does not require the addition of any other sealing part: the contact of the seal 100 against the other portions of the battery 1 generates the seal tightness. During the clamping, the uniformity of the stresses is improved relative to a system comprising a rigid piece bearing against a piece of high deformability. Slippage effects, rubbing and deterioration that could result therefrom are avoided. Furthermore, the clamping force thresholds required to ensure the seal tightness are lower than those of existing systems.

Tests on the seals shown in the figures were carried out by the Applicant. Batteries comprising at least 100 cells, or even at least 150, 200 or even 300 cells resist pressures of about 45 bars, i.e. of about one and a half times the expected operating pressure (30 bars), under a clamping pressure in the stacking direction XX of about 2000 to 5000 daN.

The invention is not limited to the exemplary seals, cells and batteries described above, only by way of example, but encompasses any variant envisionable by those skilled in the art within the scope of the claims below. In particular, the exemplary nominal dimensions will possibly be adapted to the intended application.

1. A seal for an electrolyzer battery, comprising:
a generally annular core having two faces that are mutually opposite in a thickness direction (XX), and at least two through-apertures extending in the thickness direction (XX) and which are substantially radially opposite each other; and
an envelope at least partially covering the two faces while leaving the two apertures at least partially free,
and comprising at least one first rib extending, over a first of the two faces, along a contour enclosing an internal edge of the core and the two apertures so as to allow a fluid to flow between the two faces in the thickness direction (XX).

2. The seal as claimed in claim 1, in which the envelope has a configuration and a composition that are adapted so as to electrically insulate two members making contact with one and the other of the two faces, respectively.

3. The seal as claimed in claim 1, in which the core has contains a metallic composition and in which the envelope contains an elastomer-based composition.

4. The seal as claimed in claim 3, in which the envelope contains a composition comprising ethylene-propylene-diene monomer (EPDM).

5. The seal as claimed in claim 1, in which the envelope adheres to the core.

6. The seal as claimed in claim 1, in which the envelope furthermore has at least one second rib protruding from the first face and extending between the first rib and an external edge of the core.

7. The seal as claimed in claim 6, in which the second rib extends along an open contour partially encircling the first rib.

8. The seal as claimed in claim 1, in which the core furthermore comprises two additional through-apertures that extend in the thickness direction (XX) and that are substantially radially opposite each other,
the envelope leaving the two additional apertures at least partially free, the envelope furthermore comprising two additional ribs extending, over the first face, along a contour enclosing each of the two additional apertures, respectively.

9. The seal as claimed in claim 8, in which one of the two apertures and one of the two additional apertures are close to each other.

10. The seal as claimed in claim 1, in which at least one rib has an asymmetric cross section so that crushing said rib in the thickness direction (XX) generates an asymmetric deformation of said rib.

11. The seal as claimed in claim 10, in which the cross section has a generally trapezium shape.

12. The seal as claimed in claim 1, in which the envelope has a rib extending, over the second of the two faces, along a contour enclosing the internal edge, which rib is shaped so that the rib deforms essentially in the thickness direction (XX) in response to crushing in the thickness direction (XX).

13. The seal as claimed in claim 1, in which an external edge of the core has at least one abutment zone able to interact with a guide of an electrolyzer battery in order to immobilize the seal in said electrolyzer battery in a direction perpendicular to the thickness direction (XX).

14. An electrochemical cell comprising two seals as claimed in claim 1 and mutually placed so that the second of the two faces of the two seals are mutually facing.

15. An electrolyzer battery comprising a stack of electrochemical cells as claimed in claim 14.
